(19) United States
(12) Patent Application Publication
(10) Pub. No.: US 2026/0180674 A1
(43) Pub. Date: Jun. 25, 2026

(54) DUAL FEEDER PLUS INTER-SATELLITE LINK ANTENNA SYSTEM

(71) Applicant: Hughes Network Systems, LLC, Germantown, MD (US)

(72) Inventors: Stanley Kay, Fayetteville, NC (US); Victor Liau, Gaithersburg, MD (US); Lin-Nan Lee, Potomac, MD (US)

(21) Appl. No.: 18/987,105

(22) Filed: Dec. 19, 2024

(51) Int. Cl. H04B 7/185; H04B 7/195

(52) U.S. Cl. CPC H04B 7/18521; H04B 7/18528; H04B 7/18573; H04B 7/195

(57) ABSTRACT

Systems and methods are described for satellite communications with dual feeder plus inter-satellite link (FISL) antenna systems. A satellite can have one or more (e.g., two or three) FISL antenna systems. Each FISL antenna systems can include a FISL antenna and an articulating structure. The FISL antenna can transmit and receive radiofrequency signals over a range of frequencies supporting both feeder-link (FL) and inter-satellite link (ISL) communications. The articulating structure mounts the antenna to a satellite and can mechanically steer a mechanical boresight of the antenna between a FL configuration (e.g., pointing generally Earthward) and an ISL configuration (e.g., pointing generally in the direction of an adjacent satellite in its constellation). Ground-based scheduling can be used to direct the satellite as to when to steer each FISL antenna to each configuration.

### BACKGROUND

Recent enhancements in global connectivity have largely been facilitated by significant advancements in both satellite design and network capabilities. Communication satellites are generally classified into three main types based on their orbits. Geostationary Earth orbit (GEO) satellites are generally positioned in a geosynchronous orbit approximately 35,786 kilometers above the equator, so as to remain fixed relative to a point on the surface of the Earth. Medium Earth orbit (MEO) satellites typically orbit the Earth at altitudes between around 2,000 and 35,786 kilometers. Low Earth orbit (LEO) satellites typically orbit the Earth at altitudes ranging from about 160 to 2,000 kilometers. Different satellites can also vary widely in size and capabilities. For example, some satellite chassis are approximately the size of a bus, while other chassis are approximately the size of a 10-centimeter cube.

Any such satellites can be deployed as part of a constellation. Some satellite constellations include several (e.g., tens of) satellites, while other constellations include hundreds or even thousands of satellites. The satellites typically communicate with ground-based infrastructures (e.g., gateways) via one or more feeder links, and some additionally communicate with adjacent satellites in their constellation via inter-satellite links (ISLs). ISLs allow direct communication between satellites without relaying data back to the Earth, which can enhance the reliability, robustness, and speed of communications.

Deployments of large satellite constellations with feeder link and ISL communication capabilities help to enable next-generation high-speed satellite communications. For example, a notable recent development in satellite communications has been fifth-generation wireless (5G) non-terrestrial network (NTN) technologies, which combine satellite and terrestrial networks to enable broader and more reliable global coverage. Such integrations typically leverage LEO satellite constellations with hundreds or thousands of satellites working in unison.

### SUMMARY

Systems and methods are described herein for dual feeder plus inter-satellite link (FISL) antenna systems in constellations of communication satellites. A satellite can have one or more (e.g., two or three) FISL antenna systems. Each FISL antenna systems can include a FISL antenna and an articulating structure. The FISL antenna can transmit and receive radiofrequency signals over a range of frequencies supporting both feeder-link (FL) and inter-satellite link (ISL) communications. The articulating structure mounts the antenna to a satellite and can mechanically steer a mechanical boresight of the antenna between a FL configuration (e.g., pointing generally Earthward) and an ISL configuration (e.g., pointing generally in the direction of an adjacent satellite in its constellation). Ground-based scheduling can be used to direct the satellite as to when to steer each FISL antenna to each configuration.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a satellite communication system with a constellation of satellites as a context for embodiments described herein.

FIG. 2A shows an illustrative first satellite communication case in which a satellite is directly in communication with one or more gateways.

FIG. 2B shows an illustrative second satellite communication case in which a first satellite is in communication with a gateway via a feeder link and with an adjacent satellite in its constellation via an inter-satellite link (ISL).

FIG. 2C shows an illustrative third satellite communication case in which a first satellite is in communication with a second (adjacent) satellite in its constellation via a first ISL and with a third (adjacent) satellite in its constellation via a second ISL.

FIG. 3 shows an illustrative conventional satellite having feeder-link antennas and ISL antennas.

FIG. 4 shows a simplified block diagram of an illustrative conventional satellite payload with both feeder-link antennas and ISL antennas.

FIGS. 5A and 5B show an illustrative satellite structure that includes dual feeder plus ISL (FISL) antennas, according to some embodiments herein.

FIG. 6A shows an illustrative feeder-link configuration of a FISL antenna assembly having a FISL antenna mounted to an articulating structure.

FIG. 6B shows an illustrative ISL configuration of a FISL antenna assembly having a FISL antenna mounted to an articulating structure.

FIG. 7 shows a simplified block diagram of an illustrative satellite payload with FISL antennas, according to embodiments described herein.

FIG. 8 shows a flow diagram of an illustrative method for satellite communications using dual feeder plus inter-satellite link (FISL) antennas, according to embodiments described herein.

### DETAILED DESCRIPTION

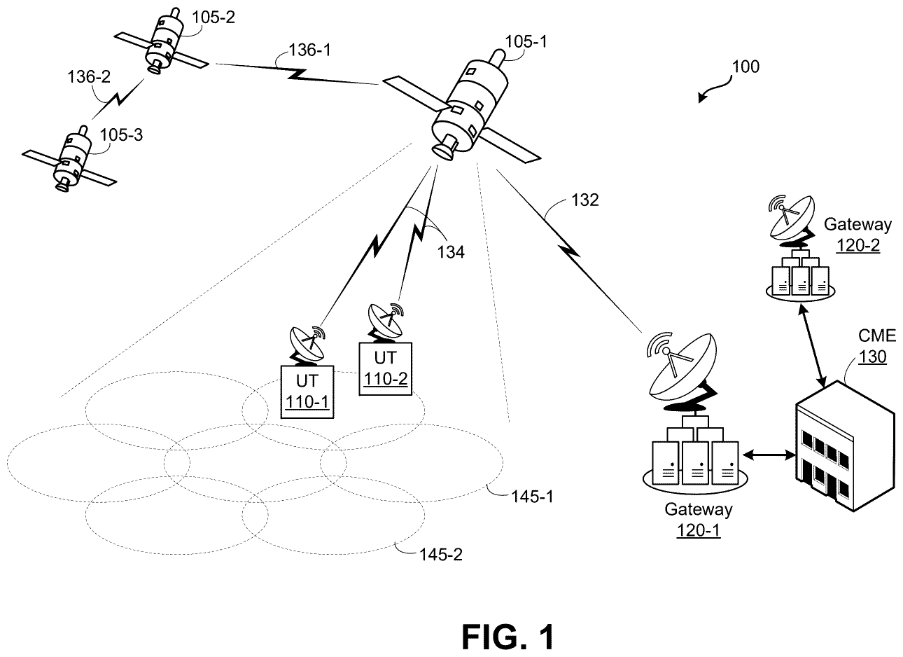

FIG. 1 shows an example of a satellite communication system 100 with a constellation of satellites 105 as a context for embodiments described herein. As illustrated, the satellite communication system 100 includes one or more gateway terminals 120 in communication with a large number of geographically diverse user terminals (UTs) 110 via the constellation of satellites 105. The UTs 110 are located in cells 145. The gateway terminals 120 are further in communication with a central management entity (CME) 130 via a terrestrial infrastructure.

The satellites 105 can include any suitable type of communication satellite. In some implementations, some or all of the satellites 105 are geostationary Earth orbit (GEO) satellites. Such GEO satellites are generally positioned in a geosynchronous orbit approximately 35,786 kilometers above the equator, so as to remain fixed relative to a point on the surface of the Earth. In other implementations, some or all of the satellites 105 are non-geosynchronous orbit (NGSO) satellites, such as medium Earth orbit (MEO) satellites that typically orbit the Earth at altitudes between around 2,000 and 35,786 kilometers, and/or low Earth orbit (LEO) satellites that typically orbit the Earth at altitudes ranging from about 160 to 2,000 kilometers. In some implementations, some or all of the satellites 105 can have large chassis. For example, a satellite 105 can have a chassis approximately the size of a bus. In other implementations, some or all of the satellites 105 can have small chassis. For example, so-called “smallsats” can include femtosatellites typically weighing less than 100 grams, picosatellites typically weighing between 100 grams and 1 kilogram, nanosatellites typically weighing between 1 and 10 kilograms, microsatellites typically weighing between 10 and 100 kilograms, and minisatellites typically weighing between 100 and 500 kilograms. As one common example, so-called “CubeSats” are a type of nanosatellite with a standard CubeSat unit (1U) defined as a 10 cm cube with a mass up to 1.33 kilograms.

Embodiments herein assume that the satellites 105 are deployed as part of a constellation. Some satellite constellations include several (e.g., tens of) satellites, while other constellations include hundreds or even thousands of satellites. As illustrated, the satellites 105 communicate with UTs 110 via one or more user links 134 and with ground-based infrastructures (e.g., gateways 120) via one or more feeder links 132. Some or all of the satellites 105 also communicate with adjacent satellites in their constellation via inter-satellite links (ISLs) 136. ISLs 136 allow direct communication between satellites without relaying data back to the Earth, which can enhance the reliability, robustness, and speed of communications. In some implementations, the ISLs 136 facilitate communication between adjacent satellites 105 sharing a same orbital plane. In other implementations, the ISLs 136 facilitate communication between satellites 105 in adjacent orbital planes.

Deployments of large satellite 105 constellations with both feeder link 132 and ISL 136 communication capabilities helps to enable next-generation high-speed satellite communications. For example, a notable recent development in satellite communications has been fifth-generation wireless (5G) non-terrestrial network (NTN) technologies, which combine satellite and terrestrial networks to enabling broader and more reliable global coverage. For example, a terrestrial cellular 5G network can be extended by leveraging a large LEO satellite constellation with hundreds or thousands of satellites working in unison.

As illustrated, the communication system 100 includes a centralized management entity (CME) 130. The CME 130 can be implemented as one or more entities in one or more locations to provide features associated with orchestration and optimization of network operations, including scheduling, resource allocation, traffic management, and overall network coordination. In some implementations, the CME 130 is located at one or more central ground stations. In other implementations, the CME 130 is located at an operations center, such as a network operations center (NOC), a satellite operations center (SOC), global network operations center (GNOC), etc. In such locations, the CME 130 has access to robust computational resources and high-bandwidth terrestrial connectivity by which to effectively monitor and control the entire satellite network infrastructure. The CME 130 can communicate with gateways 120 through high-speed terrestrial links and/or dedicated satellite communication channels.

As described herein, embodiments involve scheduling of satellite communications at least via feeder links 132 and ISLs 136 and also control of physical reconfiguration of dual feeder plus ISL (FISL) antennas on the satellites 105. In some embodiments, such features are directed by the CME 130. Implementations of the CME 130 can use standardized protocols and interfaces, such as the Satellite Network Management Protocol (SNMP) or custom APIs, to ensure interoperability and efficient data exchange. In some implementations, control of physical reconfiguration of dual feeder plus ISL (FISL) antennas on the satellites 105 is directed by the CME 130 via Telemetry, Tracking, and Command (TT&C) signals either sent directly from dedicated TT&C antenna locations or as a dedicated data channel within the feeder links vias the gateways 120.

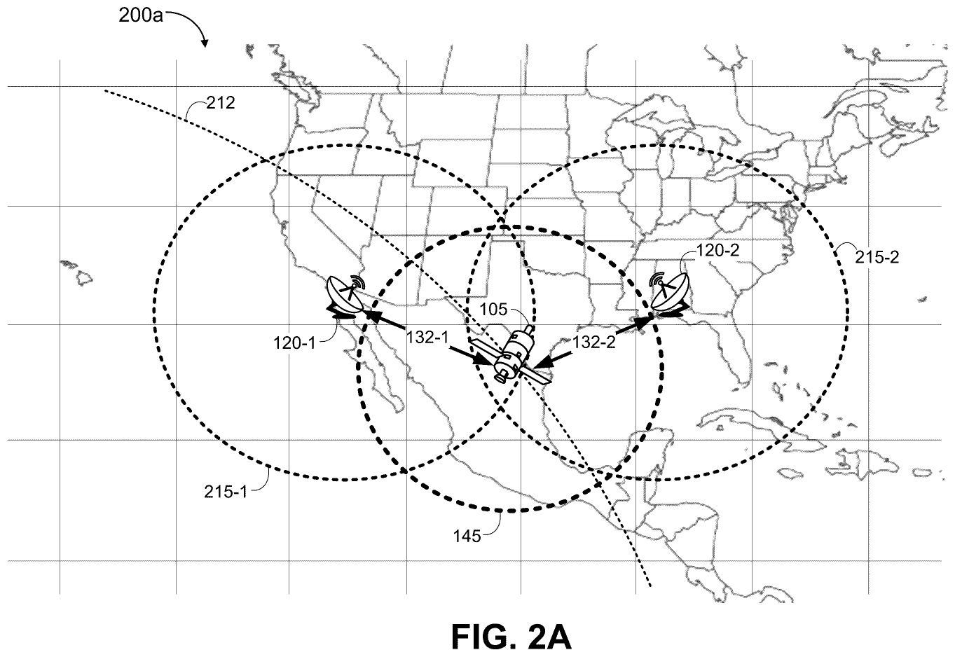

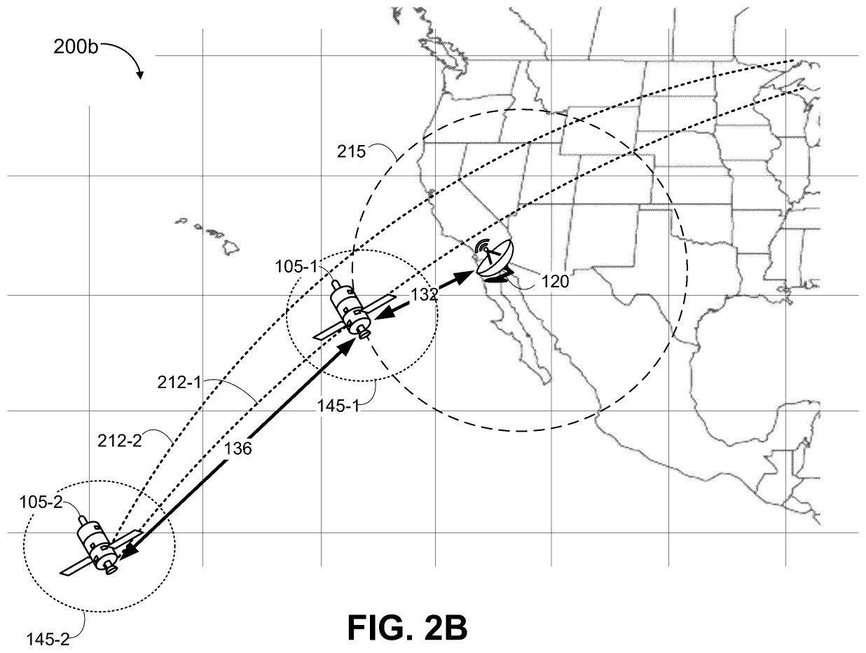

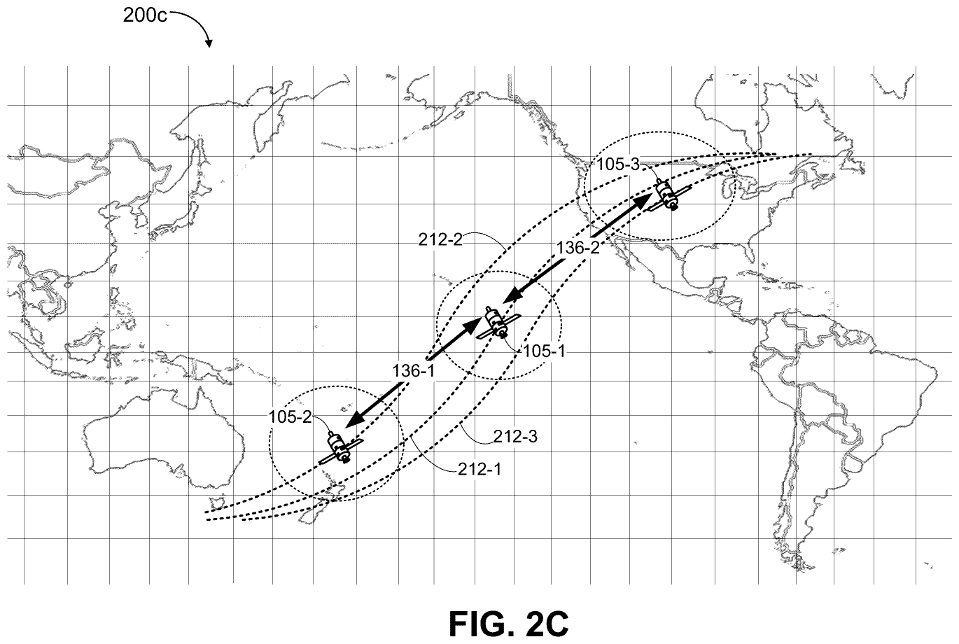

To facilitate satellite communications with feeder links 132 and ISLs 136, three categories of cases can be considered, as illustrated by FIGS. 2A-2C. FIG. 2A shows an illustrative first satellite communication case 200a in which a satellite 105 is directly in communication with one or more gateways 120. For example, the satellite 105 is an NGSO satellite shown traversing an orbital path 212 and having a moving beam coverage area 145 (e.g., a field of view corresponding to a 20-degree minimum elevation angle, MEA). Each gateway 120 has its own respective gateway field of view 215 (e.g., assuming a 15-degree MEA). As illustrated, in its current position, the satellite 105 is in view of two gateways 120 and can communicate directly with either or both of those gateways 120 via a respective feeder link 132.

As one typical scenario for this first case, it is desired to hand off communications with the satellite 105 from the first gateway 120-1 to the second gateway 120-2 as the satellite 105 traverses its orbital path 212. To facilitate a seamless handoff, it can be desirable to ensure that the satellite 105 establishes feeder-link communications with the second gateway 120-2 before ending communications with the first gateway 120-1 (i.e., “make before break”). This can rely on the satellite 105 having at least two feeder-link antennas.

FIG. 2B shows an illustrative second satellite communication case 200b in which a first satellite 105-1 is in communication with a gateway 120 via a feeder link 132 and with an adjacent satellite 105-2 in its constellation via an ISL 136. For example, each satellite 105 is an NGSO satellite shown traversing a respective orbital path 212 and having a respective moving beam coverage area 145 (e.g., a field of view corresponding to a 20-degree MEA). Each gateway 120 has its own respective gateway field of view 215 (e.g., assuming a 15-degree MEA). As illustrated, in the current positions, satellite 105-1 is in view of and in direct communication with gateway 120, but satellite 105-2 is not in view of any gateways 120.

As one typical scenario for this second case, satellite 105-1 is facilitating communications between satellite 105-2 and the ground infrastructure (gateway 120). In this way, satellite 105-2 communicates with the gateway 120 via its ISL 136 to satellite 105-1. To facilitate this scenario, it can be desirable to ensure that the satellite 105-1 is maintaining both a feeder link 132 to the gateway 120 and an ISL 136 to satellite 105-2. This can rely on the satellite 105-1 having at least a feeder-link antenna and an ISL antenna.

FIG. 2C shows an illustrative third satellite communication case 200c in which a first satellite 105-1 is in communication with a second (adjacent) satellite 105-2 in its constellation via a first ISL 136-1 and with a third (adjacent) satellite 105-3 in its constellation via a second ISL 136-2. For example, each satellite 105 is an NGSO satellite shown traversing a respective orbital path 212 and having a respective moving beam coverage area 145 (e.g., a field of view corresponding to a 20-degree MEA). Though not explicitly shown, it can be assumed that satellite 105-3 is in view of and in direct communication with a gateway 120. Satellites 105-1 and 105-2 are not in view of any gateways 120.

As one typical scenario for this third case, satellite 105-3 is facilitating communications between the ground infrastructure (gateway 120) and both satellites 105-1 and 105-2, and satellite 105-1 is also facilitating communications for satellite 105-2. In particular, satellite 105-1 communicates with the ground infrastructure via its ISL 136-2 to satellite 105-3; and satellite 105-2 communicates with the ground infrastructure via its ISL 136-1 to satellite 105-1 and ISL 136-2 to satellite 105-3. To facilitate this scenario, it can be desirable to ensure that satellite 105-1 is maintaining both an ISL 136-1 to satellite 105-2 and an ISL 136-2 to satellite 105-3. This can rely on the satellite 105-1 having at least two ISL antennas.

To support all the categories of cases represented by FIGS. 2A-2C, it can be desirable for satellites 105 to have at least two feeder-link antennas and at least two ISL antennas. In some other cases, additional antennas enable additional features. For example, additional feeder-link antennas can be used to support more concurrent feeder-links 132 and/or different feeder-link frequency bands, and additional ISL antennas can be used to establish more ISLs 136 (e.g., to support both intra-plane and inter-plane communications).

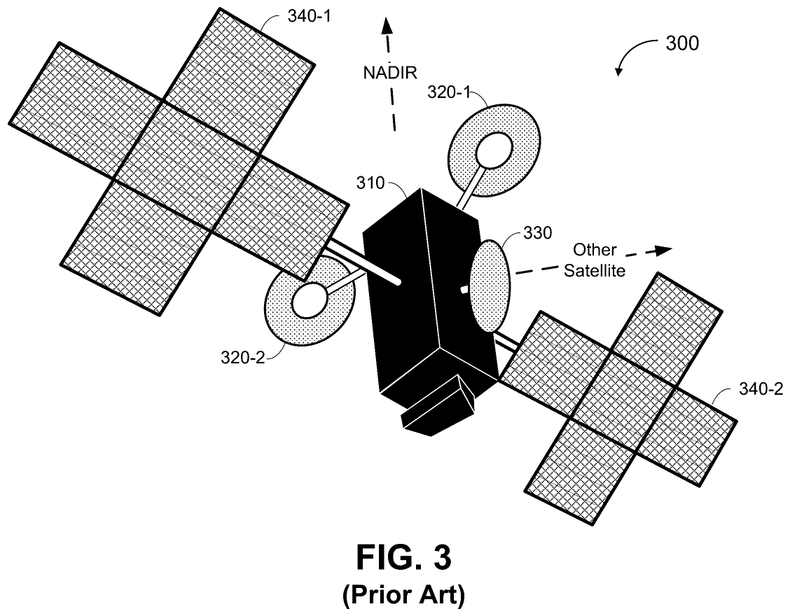

FIG. 3 shows an illustrative conventional satellite 300 having feeder-link antennas 320 and ISL antennas 330. As illustrated, the satellite 300 includes a chassis 310 having, mounted thereon, feeder-link antennas 320, ISL antennas 330, and solar panels 340. Each feeder-link antenna 320 can be affixed to a mounting structure that physically points the feeder-link antenna 320 toward the Earth while the satellite 300 is in orbit. For example, the feeder-link antennas 320 are pointed in the “nadir” direction of the satellite 300 (or in a predictable direction referenced to the nadir). The feeder-link antenna 320 can have a phased array of antenna elements, or the like, which can be used to electronically steer the boresight of the feeder-link antenna 320 to point at a particular gateway 120 on the ground. Assuming the nadir direction is 90 degrees, the feeder-link antennas 320 can be configured to point in a range of 90±F degrees. For example, F can be 60 (i.e., the feeder-link antennas 320 point between 90 degrees and 30 degrees, which roughly corresponds to the 15-degree MEA for the gateway).

Each ISL antenna 330 can be affixed to a mounting structure that physically points the ISL antenna 330 generally in a direction of a particular adjacent satellite of the constellation when the constellation is in orbit. Depending on which adjacent satellite is intended to use the ISL, the direction can be towards the zenith (directly overhead), towards the horizon, or in various horizontal directions. Typically, the direction of the ISL antenna 330 pointing is significantly different from the nadir direction, such as within 25 degrees of horizontal (zero degrees). For example, the ISL antenna 330 can be steered to a constant elevation angle toward an in-plane, adjacent satellite, such as 22.5 degrees when there are 8 satellites per orbital plane, 18.0 degrees when there are 10 satellites per orbital plane, 15.0 degrees when there are 12 satellites per orbital plane, etc. For ISL antenna 330 pointing between inter-plane satellites, the elevation angle can typically span a range between single-digit degrees and close to zero degrees. Also, the ISL antenna may point 360 degrees in azimuth if the satellite performs yaw steering to point its fixed solar panels optimally towards the sun.

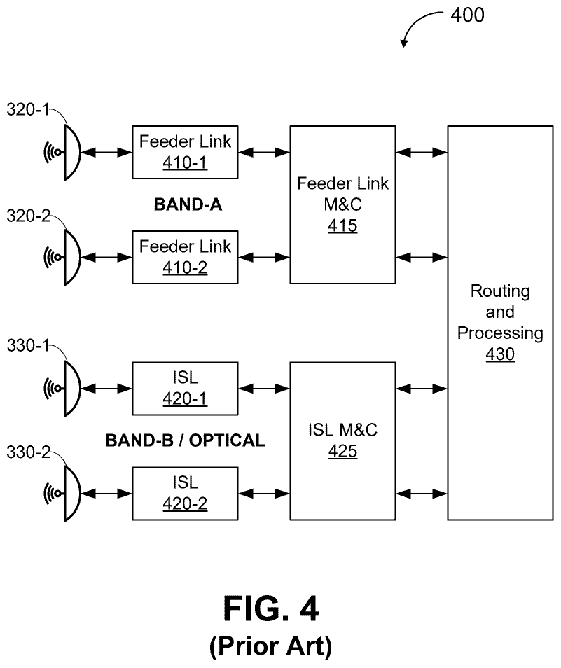

In conventional satellites, such as the satellite 300 of FIG. 3, the feeder-link antennas 320 and ISL antennas 330 typically operate in separate bands and use separate communication and processing paths, including separate transponders. FIG. 4 shows a simplified block diagram of an illustrative conventional satellite payload 400 with both feeder-link antennas 320 and ISL antennas 330. As illustrated, a first feeder-link antenna 320-1 is coupled with a first feeder-link signal path 410-1, and a second feeder-link antenna 320-2 is coupled with a second feeder-link signal path 410-2. Both operate in a feeder-link band, labeled “Band-A.” For example, Band-A may typically be C-band (approximately 4-8 GHz), Ku-band (approximately 12-18 GHz), Ka-band (approximately 26.5-40 GHz), or Q/V-band (approximately 33-75 GHz).

The feeder-link signal paths 410 both couple with a feeder-link modulation and control (M&C) block 415. The feeder-link M&C block 415 can provide several features. One such feature is modulation/demodulation of the feeder-link signal, which involves converting between the radiofrequency (RF) signals transmitted or received by the feeder-link antennas 320 and digital data used for processing. Various modulation schemes can be used, such as QPSK, 8PSK, QAM, etc., depending on a desired balance between data rate and robustness against noise and interference. The feeder-link M&C block 415 also performs coding/decoding. This can involve use of error correction coding schemes, such as convolutional coding, Turbo coding, LDPC (Low-Density Parity-Check) coding, etc. In some cases, the feeder-link M&C block 415 can perform signal shaping and/or filtering, data scrambling and/or interleaving, and/or other functions.

In separate paths, a first ISL antenna 330-1 is coupled with a first ISL signal path 440-1, and a second ISL antenna 330-2 is coupled with a second ISL signal path 420-2. Both operate in an ISL band, labeled “Band-B/Optical.” For example, some ISLs are optical links that use optical antennas and optical bands. Other ISLs can use radiofrequency bands, such as Ka-band or V-band. As one real-world example, in the receive direction, the feeder-link operates in a frequency range of approximately 29.1-30.0 GHz and the ISL operates in a frequency range of approximately 30.3-30.5 GHz. In the transmit direction, the feeder-link operates in a frequency range of approximately 18.8-20.2 GHz, and the ISL operates in a frequency range of approximately 22.55-22.75. The ISL signal paths 420 both couple with an ISL M&C block 425. The ISL M&C block 425 can perform essentially the same functions as the feeder-link M&C block 415, except configured for the types of modulation and coding applied to the ISL signal, in the ISL band, etc.

Both the feeder-link M&C block 415 and the ISL M&C block 425 are in communication with a routing and processing block 430. The routing and processing block 430 can effectively act as a central hub for managing data flow and ensuring efficient communication across the satellite payload. One function of the routing and processing block 430 in the illustrated architecture is to route feeder-link communications to and from the feeder-link paths (i.e., the feeder-link antennas 320, feeder-link signal paths 410, and feeder-link M&C block 415) and to route ISL communications to and from the ISL paths (i.e., the ISL antennas 330, ISL signal paths 420, and ISL M&C block 425). In some cases, the routing and processing block 430 can perform related routing functions, such as routing data packets, managing allocation of resources, prioritizing traffic, etc. The routing and processing block 430 can also perform processing functions on bother the feeder-link and ISL signals. For example, the routing and processing block 430 can perform packet inspection, classification, filtering, data encapsulation/decapsulation, data compression/decompression, health monitoring, etc.

In general, FIGS. 3 and 4 illustrate that conventional satellites have separate paths for feeder-link and ISL communications. For example, the antennas, RF electronics, baseband processing, and/or other features are implemented separately and tailored differently for the different ISL and feeder-link paths. Embodiments described herein implement dual feeder plus ISL (FISL) antennas for which a single antenna can be toggled between a feeder-link configuration and an ISL configuration. As described herein, embodiments of the FISL antenna are mounted to articulating structure that can mechanically steer the antenna over a range of positions suitable for both feeder-link operation and ISL operation. The feeder-links and ISLs can be configured to use the same or very close frequency bands for the ISL and feeder links and to use modulation and coding schemes applicable to both the ISL and feeder-link signals.

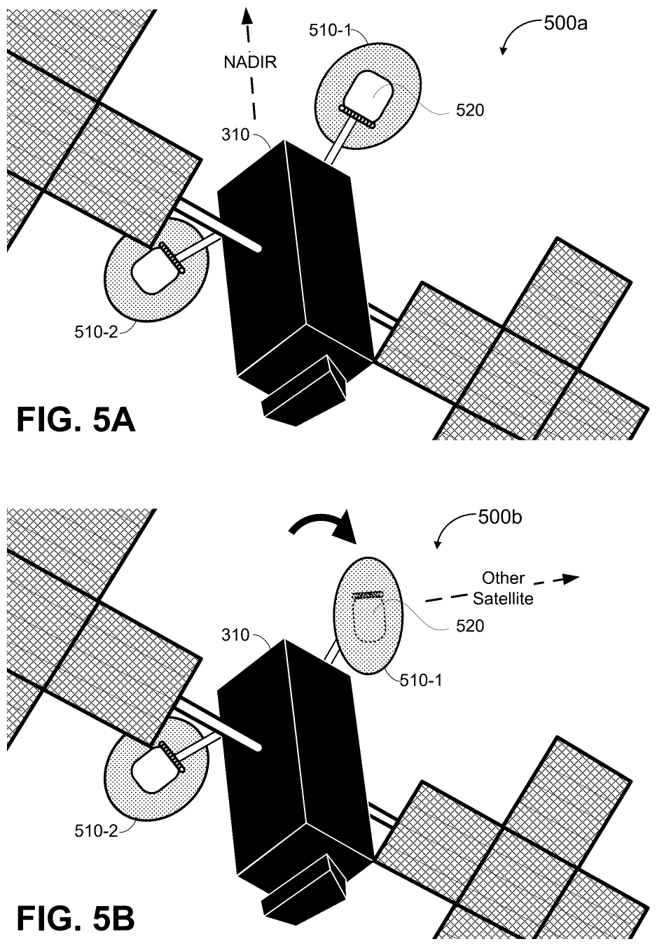

FIGS. 5A and 5B show an illustrative satellite 500 structure that includes dual feeder plus ISL (FISL) antennas 510, according to some embodiments herein. The satellite 500 is shown in both FIGS. 5A and 5B with two FISL antennas 510, labeled 510-1 and 510-2. Both are mounted to a satellite chassis 310 by an articulating structure 520. In FIG. 5A, the satellite 500a is shown with both FISL antennas 510 mechanically steered (i.e., by their respective articulating structures 520) into their feeder-link configuration.

In the feeder link configuration, the FISL antennas 510 are physically pointing in a direction corresponding to some ground terminal (e.g., gateway terminal) on the Earth. A feeder-link reference direction can be predefined as a center of a range of directions used for feeder-link communications. In some implementations, the predefined feeder-link reference direction corresponds to a nadir direction of the satellite. For the sake of convention in this context, the predefined feeder-link reference direction (e.g., the nadir direction) can be defined as 0 degrees. The FISL antennas 510 are configured to be able to maintain pointing in the direction of some particular ground terminal for as long at the ground terminal is in view of the satellite 500 (e.g., at least while the satellite 500 is within the MEA of the ground terminal), such as from when the satellite 500 rises at one horizon until the satellite 500 sets at an opposite horizon. At an orbital altitude of around 670 kilometers, this can correspond to a feeder-link pointing range of approximately ±60 degrees from the feeder-link reference direction (e.g., 0±60 degrees, or −60 to +60 degrees). At different orbital altitudes, the feeder-link pointing range can be computed geometrically.

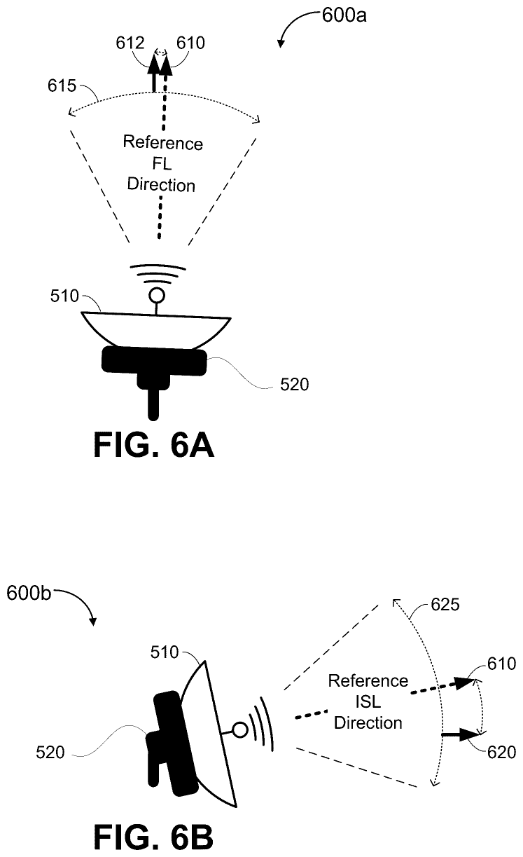

For example, FIG. 6A shows an illustrative feeder-link configuration of a FISL antenna assembly 600a having a FISL antenna 510 mounted to an articulating structure 520. As illustrated, the articulating structure 520 mechanically steers the FISL antenna 510, so that it mechanically points in a reference feeder-link (FL) direction. For the sake of clarity and consistency, the term “mechanical boresight” or “mechanical boresight direction” is used herein to refer to the physical pointing direction of the antenna. For example, if the antenna has no electronic beam steering so that its boresight is always based solely on the direction in which the antenna is mechanically pointed, that direction is the mechanical boresight direction. Terms, like “beam pointing direction,” “beam steering angle,” or “electronic boresight,” are used herein to describe the effective boresight of the antenna accounting for electronic beam steering capabilities of the antenna.

For reference, both the mechanical boresight direction 610 and the nadir direction 612 are shown. In the FL configuration, the mechanical boresight direction 610 can be the reference FL direction, or any suitable direction within the FL pointing range and/or to support the full FL pointing range using a combination of mechanical pointing and electronic steering. As noted above, the reference FL direction can be the same as the nadir direction 612, or close to the nadir direction 612. In general, the mechanical boresight direction 610 points toward the Earth in this configuration when the satellite is in orbit. Further, embodiments of the FISL antenna 510 can use electronic beam steering (e.g., using phased array antenna elements) to point the electronic boresight of the antenna over a range of beam steering angles to either side of the reference FL direction (i.e., the FL pointing range), as illustrated by arrow 615.

For example, in the FL configuration, the FISL antenna 510 is mechanically steered by the articulating structure 520 so that its mechanical boresight direction 610 generally points Earthward, and electronic beam steering is used to point its beam (i.e., its electronic boresight) at a particular gateway on the ground. In some implementations, the range of beam steering angles (i.e., arrow 615) is nominally symmetric around the mechanical boresight direction 610. In other implementations, the range of beam steering angles (i.e., arrow 615) is asymmetric around the mechanical boresight direction 610.

Turning back to FIG. 5B, the satellite 500b is shown with FISL antenna 510-2 still in the feeder-link configuration, and FISL antenna 510-1 mechanically steered (i.e., by its articulating structure 520) into its ISL configuration. In the ISL configuration, the FISL antenna 510-1 is physically pointing toward a predefined ISL reference direction. In the ISL configuration, the FISL antenna 510-1 is physically pointing in a direction corresponding to some other satellite in its constellation (e.g., inter-plane or intra-plane). An ISLreference direction can be predefined as a center of a range of directions used for ISL communications. In some implementations, the predefined ISL reference direction is 90 degrees from the nadir direction of the satellite. For the sake of convention in this context, the predefined ISL reference direction can be defined as 90 degrees. The FISL antennas 510 are configured to be able to point in the direction of one or more other satellites in one or more inter-and/or intra-plane constellation locations. In some implementations, this corresponds to an ISL pointing range of approximately ±22 degrees from the ISL reference direction (e.g., 90±22 degrees, or 68 to 112 degrees). Different ISL pointing ranges can be used to support different constellation configurations.

For example, FIG. 6B shows an illustrative ISL configuration of a FISL antenna assembly 600b having a FISL antenna 510 mounted to an articulating structure 520. As illustrated, the articulating structure 520 mechanically steers the mechanical boresight direction 610 of the FISL antenna 510, so that it mechanically points in a reference ISL direction, or any suitable direction within the ISL pointing range and/or to support the full ISL pointing range using a combination of mechanical pointing and electronic steering. For reference, the horizontal direction 620 is also shown. As noted above, the reference ISL direction can be the same as the horizontal direction 620, within a few degrees of the horizontal direction, or at any suitable elevation angle depending on locations of adjacent satellites in the constellation. As in the feeder-link configuration, embodiments of the FISL antenna 510 can use electronic beam steering (e.g., using phased array antenna elements) to point the electronic boresight of the antenna over a range of beam steering angles to either side of the reference ISL direction, as illustrated by arrow 625. For example, in the ISL configuration, the FISL antenna 510 is mechanically steered by the articulating structure 520 so that the mechanical boresight direction 610 generally points toward an adjacent satellite, and electronic beam steering is used to fine-tune the electronic boresight for tracking of the adjacent satellite participating in the ISL.

As noted above, the limits of the FL pointing range and the ISL pointing range of the FISL antennas 510 can be configured differently to account for different satellite orbital altitudes, constellation configurations, and/or other factors. In any case, the FL pointing range and the ISL pointing range represent distinct pointing ranges configured for distinct purposes. The FL pointing range is defined so that the satellite, when in orbit, can maintain pointing in the general direction of the Earth; and the ISL pointing range is defined so that the satellite, when in orbit, can maintain pointing in the general direction of other satellites (i.e., without seeing the Earth or its atmosphere). For the following examples, assume the Earth's atmosphere extends approximately 150 km from its surface and that the nadir direction of the satellite is defined as 0 degrees. As one example, the satellite is designed to orbit at an altitude of approximately 700 km. The FISL antennas 510 have an FL configuration that supports an FL pointing range of approximately- 60 to 60 degrees, and an ISL configuration that supports an ISL pointing range of approximately 68 to 112 degrees. As another example, the satellite is designed to orbit at an altitude of approximately 200 km. The FISL antennas 510 have an FL configuration that supports an FL pointing range of approximately- 75 to 75 degrees, and an ISL configuration that supports an ISL pointing range of approximately 83 to 97 degrees. As another example, the satellite is designed to orbit at an altitude of approximately 2,000 km. The FISL antennas 510 have an FL configuration that supports an FL pointing range of approximately −49.5 to 49.5 degrees, and an ISL configuration that supports an ISL pointing range of approximately 51.5 to 128.5 degrees.

Descriptions herein primarily focus on implementations in which the FISL antenna 510 is configured to toggle between one of two configurations: a feeder-link configuration corresponding to a first range of pointing directions, and an ISL configuration corresponding to a second range of pointing directions. In other implementations, the FISL antenna 510 is configured to operate in a shell configuration. A shell constellation is a structured arrangement of satellites within a satellite network where there may be multiple cohesive “shells,” and each shell represents a group of satellites orbiting at the same or similar altitude and inclination. For example, each shell can have unique orbital characteristics optimized for specific coverage areas and performance requirements, such as differing altitudes and inclinations, and the multiple shells can be strategically positioned to provide comprehensive and overlapping coverage of the Earth's surface. In such contexts, one or more FISL antennas 510 on one or more satellites in one or more of the shells can be configured to be mechanically pointed in a reference shell direction that corresponds to a satellite orbiting in a different shell (e.g., at a different altitude, inclination, etc.).

For example, in shell and/or other configurations, the FISL antennas 510 have an ISL configuration that supports a much larger ISL pointing range defined based on a minimum pointing angle. As noted above, the ISL pointing range is defined at least to avoid seeing the Earth or the atmosphere (e.g., accounting for the Earth not being a perfect sphere, for atmospheric refraction, etc.). For example, the satellite is designed to orbit at an altitude of approximately 700 km, so that the FISL antennas 510 have an FL configuration that supports an FL pointing range of approximately −60 to 60 degrees. In some such contexts, the ISL configuration is designed to support an ISL pointing range of approximately 68 to 180 degrees (i.e., a minimum pointing angle of 68 degrees relative to nadir). In other such contexts, the ISL configuration is designed to support an ISL pointing range of approximately −68 to 68 degrees (i.e., at least 68 degrees away from nadir).

Further, embodiments of FISL antennas 510 described herein can be implemented on any suitable type of satellite, or other orbiting craft providing communication services as part of a constellation. In some implementations, all such craft are LEO and/or MEO satellites, which dynamically toggle between the FL and ISL configurations according to a schedule. In other implementations, one or more FISL antennas 510 are installed on a GEO satellite to act as a redundant FL or ISL antenna, as needed. For example, a GEO satellite communicating with N gateways and M ISLs can have M FL antennas, N ISL antennas, and 1 FISL antenna 510, where FISL antenna 510 provides redundancy in the case of failure of either a FL antenna or an ISL antenna. In other implementations, one or more FISL antennas 510 can be implemented on other orbiting craft, such as high-altitude platform systems (HAPS), low-altitude platform systems (LAPS), or the like, that are used as part of a constellation to provide communication services.

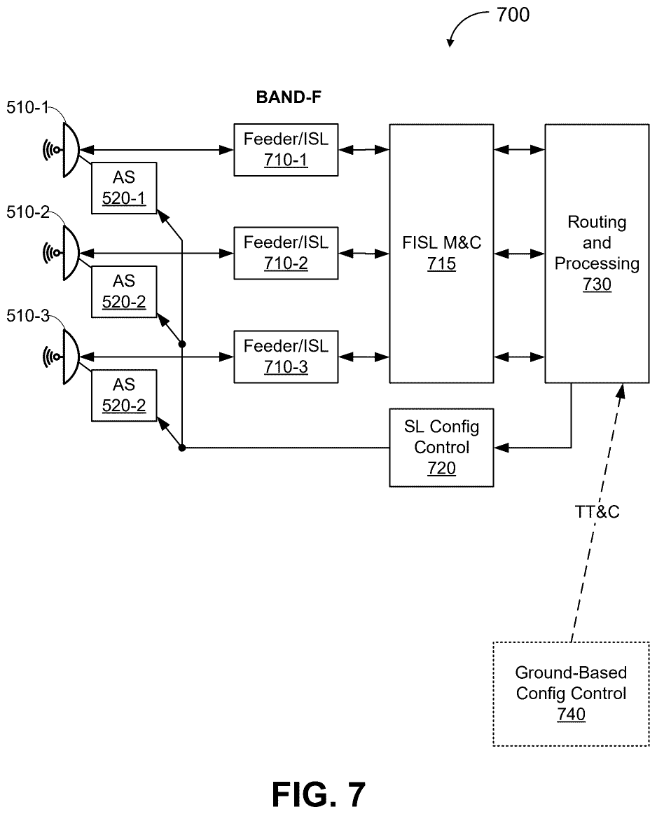

FIG. 7 shows a simplified block diagram of an illustrative satellite payload 700 with FISL antennas 510, according to embodiments described herein. The illustrated implementation includes three FISL antenna systems, each including a corresponding FISL antenna 510 and a corresponding articulating structure 520 configured to mechanically steer the mechanical boresight direction of the FISL antenna 510 between its feeder-link and ISL configurations. Another implementation has only two FISL antennas 510. Two FISL antennas 510 can support all the categories of cases described in FIGS. 2A-2C. For example, both FISL antennas 510 can be in their feeder-link configurations to support the cases of FIG. 2A, both FISL antennas 510 can be in their ISL configurations to support the cases of FIG. 2C, or one FISL antenna 510 can be in its feeder-link configuration and the other FISL antenna 510 can be in its ISL configuration to support the cases of FIG. 2B. A third FISL antenna 510, as in the illustrated implementation of FIG. 7 can be used to support make before break handovers, and/or other features. For example, more than two FISL antennas 510 (e.g., three, four, or more) can support additional feeder-link bands, support both inter-and intra-plane ISLs, and/or provide other features. Other implementations can have other numbers of FISL antennas 510. In some implementations, a subset of the antennas on the satellite can be FISL antennas 510. For example, a satellite that would conventionally have two feeder-link antennas and a single ISL antenna can be implemented using a single feeder-link antenna and a single FISL antenna 510 (i.e., taking the place of the ISL antenna and one of the feeder-link antennas).

As illustrated, a first FISL antenna 510-1 is coupled with a first FISL signal path 710-1, a second FISL antenna 510-2 is coupled with a second FISL signal path 710-2, and a third FISL antenna 510-3 is coupled with a third FISL signal path 710-3. All FISL antennas 510-1 and FISL signal paths 710 (e.g., RF electronic components, etc.) are configured to operate in band that supports both feeder-link and ISL communications, labeled “Band-F.” In some implementations, Band-F is in the Ka-Band. In one such implementation, the feeder-link transmit band is approximately 20 GHz, the feeder-link receive band is approximately 30 GHz, the ISL transmit band is approximately 22 GHz, and the ISL receive band is approximately 30 GHz.

All the FISL signal paths 710 can be coupled with an FISL modulation and coding (M&C) block 715. In some embodiments, the feeder-link and ISL signals are up-and down-converted between a baseband frequency and the desired transmit or receive frequency. Embodiments of the FISL M&C block 715 are configured to use the same modulation and coding schemes for baseband data sent over both feeder links and ISLs. For example, Digital Video Broadcasting —Satellite—Second Generation —extended (DVB-S2x) modulation and coding can be used for both. For example, the FISL M&C block 715 can apply QPSK, 8PSK, 16PSK, 32PSK, QAM, and/or other supported modulation schemes; and the FISL M&C block 715 can perform convolutional coding, Turbo coding, LDPC (Low-Density Parity-Check) coding, and/or other supported coding schemes.

As illustrated, the FISL M&C block 715 is in communication with a routing and processing block 730. Embodiments of the routing and processing block 730 can route any feeder-link or ISL communications to any of the FISL antennas 510. Further, the routing and processing block 730 can direct a configuration control block 720 to drive the articulating structures 520, as needed, to mechanically steer the FISL antennas 510 into the appropriate configurations.

For example, in a particular time slot, a signal will be received by the satellite over a feeder-link channel and transmitted by the satellite over an ISL channel. The routing and processing block 730 is aware of the scheduling of those signals and channels and can direct the configuration control block 720 to mechanically configure one of the FISL antennas 510 for the time slot as a feeder-link antenna for receiving the feeder uplink signal and mechanically configure another of the FISL antennas 510 for the time slot as an ISL antenna for transmitting the ISL signal.

Practically, it will take some amount of time to mechanically steer the mechanical boresight directions of the FISL antennas 510 between the reference FL direction and the reference ISL direction. In some implementations, that amount of time may be significantly longer than time slots, or the like. In some cases, when fewer than all the FISL antennas 510 are being used concurrently, FISL antennas 510 can be mechanically reconfigured while they are not being used for communications. In other cases, certain guard times are introduced into the scheduling to account for mechanical reconfiguration times.

For the sake of added context, a ground-based configuration control system 740 is shown. The ground-based configuration control system 740 may be implemented in the CME 130 (e.g., as described in FIG. 1), or in any suitable location or locations in the ground-based infrastructure. The ground-based configuration control system 740 generates and maintains configuration information for the entire constellation and is also aware of ground status and any other salient information. The configuration information includes beam scheduling information that indicates when to configure each FISL antenna 510 into which of its configurations. The configuration information can be sent from the ground-based configuration control system 740 on the ground up to the satellites (i.e., to the routing and processing blocks 730 of the satellites) via TT&C channels.

In some implementations, the scheduling (e.g., including designating which FISL antennas 510 on which satellites would be used in which configurations at each time) is generated for some time period and is updated according to a periodic schedule. For example, the scheduling is generated for the upcoming two days and is distributed via the TT&C channels once per day. The scheduling is generated based on orbital mechanics, gateway locations, areas to be serviced by the satellites, and any other salient information. In some cases, failures can occur that disrupt the programmed plan, such as an antenna failure on a satellite, a failure of one of the gateways, etc. In such cases, the ground-based configuration control system 740 can compute a new plan to provide the best service possible during the impaired operation.

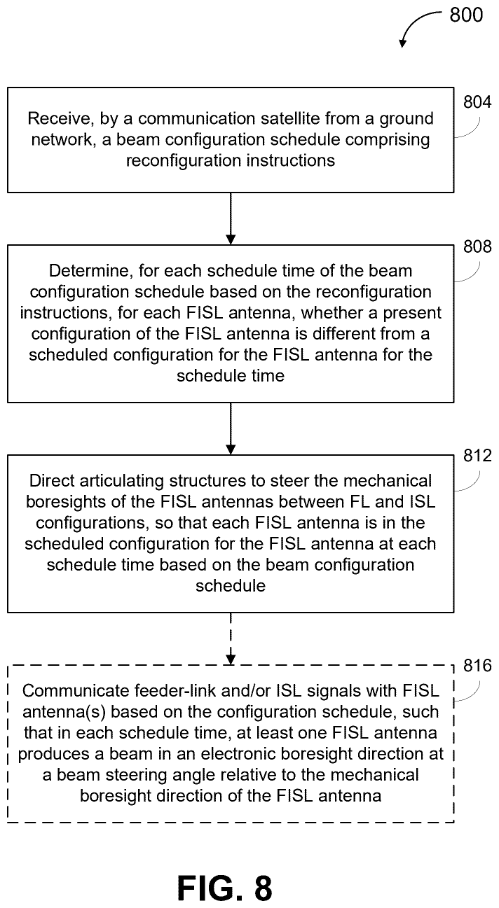

FIG. 8 shows a flow diagram of an illustrative method 800 for satellite communications using dual feeder plus inter-satellite link (FISL) antennas, according to embodiments described herein. Embodiments of the method 800 begin at stage 804 by receiving a beam configuration schedule with reconfiguration instructions. The receiving can be by a communication satellite from a ground network, such as from a central management entity via a gateway. As described herein, the communication satellite includes one or more dual feeder plus inter-satellite link (FISL) antennas and one or more articulating structures. Each FISL antenna is configured to transmit and receive radiofrequency signals over a range of frequencies supporting feeder-link (FL) and inter-satellite link (ISL) communications. Each articulating structure is configured to mount a corresponding one of the FISL antennas to the chassis of the communication satellite and to mechanically steer a mechanical boresight of the corresponding one of the FISL antennas between a FL configuration and an ISL configuration based on the reconfiguration instructions. The steering is such that the corresponding one of the FISL antennas is physically pointing in a FL direction within a range of FL pointing directions (e.g., around a reference FL direction) in the FL configuration and is physically pointing in an ISL direction within a range of ISL pointing directions (e.g., around a reference ISL direction) in the ISL configuration.

At stage 808, embodiments can determine, for each schedule time of multiple schedule times of the beam configuration schedule, based on the reconfiguration instructions, for each of the one or more FISL antennas, whether a present configuration of the FISL antenna is different from a scheduled configuration for the FISL antenna for the schedule time. For example, the beam configuration schedule defines a notional schedule for the next one or two days, and the schedule is defined according to a sequence of schedule times. In each schedule time, the schedule can indicate, for each for the FISL antennas, whether the FISL antenna should be configured in its FL configuration or in its ISL configuration. The determining in stage 808 can include determining whether the scheduled configuration differs from the configuration that the “present” configuration (i.e., the configuration that the FISL antenna would already be in upon the arrival of that schedule time).

At stage 812, embodiments can direct the one or more articulating structures to steer the mechanical boresights of the one or more FISL antennas between the FL configuration and the ISL configuration based on the determining. In this way, each FISL antenna is in its scheduled configuration at each schedule time based on the beam configuration schedule. For example, at a schedule time, t0, a particular FISL antenna is configured to be an ISL antenna (i.e., in its ISL configuration). For a subsequent schedule time, t1, the FISL antenna's configuration at t0 is its “present configuration.” In one scenario, the scheduled configuration for t1 is for the FISL antenna to be in its ISL configuration. In this scenario, the determining at stage 808 is that there is no change in configuration for that schedule time, and the directing at stage 812 does not direct any change in configuration for that FISL antenna for t1. In another scenario, the scheduled configuration for t1 is for the FISL antenna to be in its FL configuration. In this scenario, the determining at stage 808 is that there is a scheduled change in configuration for that schedule time, and the directing at stage 812 directs the determined change in configuration for that FISL antenna for t1.

In some embodiments, the method 800 further includes stage 816. At stage 816, embodiments can communicate feeder-link and/or ISL signals with the one or more FISL antennas based on the configuration schedule, such that in each schedule time, at least one FISL antenna of the one or more FISL antennas produces a beam in an electronic boresight direction at a beam steering angle relative to the mechanical boresight direction of the FISL antenna. For example, a FISL antenna is steered into its FL configuration in stage 812, so that its mechanical boresight is pointing in the reference FL direction (or any other suitable direction to support the range of FL pointing directions), and FL signals are communicated to the FISL antenna in a manner that produces a beam electronically steered to point to a particular gateway on the ground.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A dual feeder plus inter-satellite link (FISL) antenna system for a communication satellite, the FISL antenna system comprising:
an antenna configured to transmit and receive radiofrequency signals over a range of frequencies supporting feeder-link (FL) and inter-satellite link (ISL) communications;
an articulating structure configured to mount the antenna to a chassis of the communication satellite and to mechanically steer a mechanical boresight of the antenna between a FL configuration and an ISL configuration, such that the antenna is physically pointing in a FL direction that supports a range of FL pointing directions in the FL configuration and the antenna is physically pointing in an ISL direction that supports a range of ISL pointing directions in the ISL configuration, the range of FL pointing directions not overlapping the range of ISL pointing directions; and
a configuration control block configured to be installed on the communication satellite, to electrically couple with the articulating structure, and to direct the articulating structure to steer the mechanical boresight of the antenna between the FL configuration and the ISL configuration responsive to reconfiguration instructions received by the communication satellite.

2. The FISL antenna system of claim 1, wherein:
the range of FL pointing directions is defined as a range of angles around a reference FL direction of the communication satellite by which to maintain pointing at a fixed location on Earth as the communication satellite moves from one horizon to another horizon of the Earth while in orbit.

3. The FISL antenna system of claim 1, wherein:
the range of FL pointing directions reference FL direction is within 60 degrees of a nadir direction of the communication satellite.

4. The FISL antenna system of claim 1, wherein the antenna comprises a plurality of radiating elements configured for electronic beam steering over a range of beam steering angles relative to the mechanical boresight direction.

5. The FISL antenna system of claim 1, wherein the range of frequencies supporting FL and ISL communications is in the Ka-band.

6. A communication satellite comprising:
a chassis;
one or more dual feeder plus inter-satellite link (FISL) antennas, each configured to transmit and receive radiofrequency signals over a range of frequencies supporting feeder-link (FL) and inter-satellite link (ISL) communications; and
one or more articulating structures, each configured to mount a corresponding one of the FISL antennas to the chassis and to mechanically steer a mechanical boresight of the corresponding one of the FISL antennas between a FL configuration and an ISL configuration, such that the corresponding one of the FISL antennas is physically pointing in a FL direction that supports a range of FL pointing directions in the FL configuration and is physically pointing in an ISL direction that supports a range of ISL pointing directions in the ISL configuration, the range of FL pointing directions not overlapping the range of ISL pointing directions.

7. The communication satellite of claim 6, further comprising:
a configuration control block configured to electrically couple with the one or more articulating structures to direct the one or more articulating structures to steer the mechanical boresights of the one or more FISL antennas between the FL configuration and the ISL configuration responsive to reconfiguration instructions received by the communication satellite.

8. The communication satellite of claim 7, further comprising:
a routing and processing block configured to communicate with a ground infrastructure to receive data signals over one or more data channels and to receive telemetry, tracking, and command (TT&C) signals over one or more TT&C channels,
wherein the TT&C signals comprise the reconfiguration instructions.

9. The communication satellite of claim 6, further comprising:
one or more FISL signal paths each coupled with a corresponding one of the FISL antennas to carry both FL and ISL signals to and from the FISL antennas; and
a FISL modulation and control (M&C) block coupled with the one or more FISL signal paths to apply same M&C schemes to both the FL and ISL signals.

10. The communication satellite of claim 6, wherein:
the one or more FISL antennas is two FISL antenna systems; and
the one or more articulating structures is two articulating structures, each articulating structure being independently steerable by the configuration control block.

11. The communication satellite of claim 6, wherein:
the one or more FISL antennas is at least three FISL antenna systems; and
the one or more articulating structures is at least three articulating structures, each articulating structure being independently steerable by the configuration control block.

12. The communication satellite of claim 6, wherein the range of FL pointing directions is defined as a range of angles around a reference FL direction of the communication satellite by which to maintain pointing at a fixed location on Earth as the communication satellite moves from one horizon to another horizon of the Earth while in orbit.

13. The communication satellite of claim 6, wherein the range of FL pointing directions reference FL direction is within plus or minus 60 degrees of a nadir direction of the communication satellite.

14. The communication satellite of claim 6, wherein each of the one or more FISL antennas comprises a plurality of radiating elements configured for electronic beam steering over a range of beam steering angles relative to the mechanical boresight direction.

15. A method for satellite communications using dual feeder plus inter-satellite link (FISL) antennas, the method comprising:
receiving, by a communication satellite from a ground network, a beam configuration schedule comprising reconfiguration instructions,
wherein the communication satellite comprises:
one or more dual feeder plus inter-satellite link (FISL) antennas, each configured to transmit and receive radiofrequency signals over a range of frequencies supporting feeder-link (FL) and inter-satellite link (ISL) communications; and
one or more articulating structures, each configured to mount a corresponding one of the FISL antennas to a chassis of the communication satellite and to mechanically steer a mechanical boresight of the corresponding one of the FISL antennas between a FL configuration and an ISL configuration based on the reconfiguration instructions, such that the corresponding one of the FISL antennas is physically pointing in a FL direction that supports a range of FL pointing directions in the FL configuration and is physically pointing in an ISL direction that supports a range of ISL pointing directions in the ISL configuration, the range of FL pointing directions not overlapping the range of ISL pointing directions;
determining, for each schedule time of a plurality of schedule times of the beam configuration schedule based on the reconfiguration instructions, for each FISL antenna of the one or more FISL antennas, whether a present configuration of the FISL antenna is different from a scheduled configuration for the FISL antenna for the schedule time; and
directing the one or more articulating structures to steer the mechanical boresights of the one or more FISL antennas between the FL configuration and the ISL configuration based on the determining, so that each FISL antenna of the one or more FISL antennas is in the scheduled configuration for the FISL antenna at each schedule time based on the beam configuration schedule.

16. The method of claim 15, further comprising:
communicating feeder-link and/or ISL signals with the one or more FISL antennas based on the configuration schedule, such that in each schedule time, at least one FISL antenna of the one or more FISL antennas produces a beam in an electronic boresight direction at a beam steering angle relative to the mechanical boresight direction of the FISL antenna.

17. The method of claim 15, wherein:
the beam configuration schedule is generated by a central management entity implemented in the ground network; and
the receiving is from the central management entity via a telemetry, tracking, and command (TT&C) channel.

18. The method of claim 15, wherein:
the communication satellite is a low-Earth orbit (LEO) satellite of a constellation of LEO satellites.

19. The method of claim 15, wherein:
the communication satellite is one of a constellation of satellites, and the reference ISL direction points toward a predetermined adjacent LEO satellite in a same orbital plane of the constellation.

20. The method of claim 15, wherein:
the communication satellite is one of a constellation of satellites, and the reference ISL direction points toward a predetermined adjacent LEO satellite in an adjacent orbital plane of the constellation.
